(19) United States
(12) Patent Application Publication
(10) Pub. No.: US 2016/0018034 A1
(43) Pub. Date: Jan. 21, 2016

(54) MUFFLER

(71) Applicant: Friedrich Boysen GmbH & Co, KG, Altensteig (DE)

(72) Inventors: Jurgen Schmidt, Muhlacker (DE); Georg Turowski, Jettingen (DE)

(21) Appl. No.: 14/750,428

(22) Filed: Jun. 25, 2015

(30) Foreign Application Priority Data
Jul. 18, 2014 (DE) 10 2014 110 101.4

(51) Int. Cl. F16L 21/08; F16L 37/084; F16L 41/02; F01N 13/18

(52) U.S. Cl. CPC F16L 21/08; F01N 13/1811; F16L 37/084; F16L 41/023

(57) ABSTRACT

A muffler, in particular a rear muffler, for an exhaust gas system of an internal combustion engine, in particular a motor vehicle engine, comprises a housing, in particular a housing having a jacket and two end walls, and comprises at least two pipes which are plugged into one another and which are at least partly received by the housing, in particular at least one inlet or outlet pipe which is in particular led through the jacket and which is connected to an inner pipe. The first pipe has a pipe piece into which a pipe piece, in particular an end section, of the second pipe is plugged. The pipe piece of the second pipe is provided with nubs at its outer boundary which engage into cut-outs provided in the pipe piece of the first pipe. In this respect, the cut-outs are dimensioned larger with respect to the nubs so that the end section is, on the one hand, fixed in the pipe piece but can be axially displaced to a limited degree relative to the pipe piece.

The present invention relates to a muffler, in particular to a rear muffler, for an exhaust gas system of an internal combustion engine, in particular a motor vehicle engine, having a housing, in particular a housing having a jacket and two end walls, and having at least two pipes, which are plugged into one another and which are at least partly received by the housing, in particular at least one inlet pipe in particular led through the jacket into the housing or in particular at least one outlet pipe led out of the housing, said inlet or outlet pipe being connected to an inner pipe.

Such mufflers are generally known and are in particular used as standard in motor vehicles to reduce the noise level generated by the vehicle engine. They are as a rule provided with inner bases which receive the inner pipes and separate different chambers from one another. The inner bases are in this respect usually designed as stiff. The inner pipes are as a rule welded to the respective base passage. In addition, the inner bases can be welded from the outside to the jacket of the muffler housing, for example, via a respective elongated hole.

Thermal stresses arise due to different temperatures at the outer jacket and at the gas-conducting pipes, the stresses either having to be taken up by the inner bases by deformation or having to be reduced by sliding seats between the pipes. The connections between the inlet pipes or the outlet pipes and the inner pipes are in particular problematic due to the different temperatures.

It is the underlying object of the invention to provide a muffler of the initially named kind which allows a reliable compensation of thermal expansions in the region of a connection between two pipes, in particular between an inlet or outlet pipe and an inner pipe, with a design which is kept as simple as possible.

This object is satisfied in accordance with the invention in that the first pipe, in particular the inner pipe, comprises a pipe piece into or onto which a pipe piece of the second pipe, in particular the inlet or outlet pipe, is plugged, wherein a loose form-fitted connection is provided between the pipe piece of the first pipe and the pipe piece of the second pipe so that the pipe piece of the second pipe, in particular of the inlet or outlet pipe, is fixed in the pipe piece of the first pipe, in particular of the inner pipe, on the one hand, but can be axially displaced to a limited degree relative to the pipe piece of the first pipe. The pipe pieces of the first pipe and of the second pipe can in this respect each be formed by an end section or by a lateral branch of a straight or curved pipe.

A reliable compensation of thermal expansions in the critical region of a connection between two pipes, in particular between an inlet or outlet pipe and an inner pipe, is made possible due to this design with a design of the muffler which is kept simple. A compensation of thermal expansions is able to take place after the pipe piece of the inlet or outlet pipe has admittedly been fixed in or on the pipe piece by the loose form-fitted connection, but can be axially displaced to a limited degree relative to the pipe piece.

The loose form-fitted connection is preferably realized by nubs which are provided at one of the mutually associated parts and which engage into cut-outs provided at the other part which are dimensioned larger with respect to the nubs. The pipes are furthermore secured against rotation with respect to one another by the cooperating nubs and cut-outs.

The connection between the pipes which makes an axial thermal expansion possible can be established simply, whereby the installation of the muffler is simplified. The nubs provided at the outer boundary of the end section can in particular be generated from the inside after a plugging together of the pipes.

As already mentioned, the pipe piece of the second pipe is preferably received secured against rotation in the pipe piece of the first pipe by the cooperating nubs and cut-outs.

The pipe piece of the second pipe is preferably provided with an intake, i.e. with a cross-section reduction or a diameter reduction, with the pipe piece of the second pipe being plugged into the pipe piece of the first pipe. Such an intake facilitates the axial displaceability of the pipe piece of the second pipe relative to the pipe piece of the first pipe and forms an abutment. The cross-sections or diameters of the pipe pieces are in this respect coordinated with one another. An outwardly gas-tight connection between the pipes is not necessary since the housing is formed as gas-tight.

The first pipe, in particular the inner pipe, can in particular be formed as a Y pipe, with the pipe piece of the first pipe in this case being provided as a lateral branch of the Y pipe. Such a Y pipe facilitates the connection to further inner pipes. In this respect, such a Y pipe can in particular be connected to two further inner pipes. The first pipe can, however, generally also be designed in a different manner. The first pipe can also in particular be composed of two half-shells.

The nubs and the cut-outs can at least partly have an elongate form extending in the boundary direction of the pipe piece of the second pipe, in particular of the inlet or outlet pipe, or extending in the boundary direction of the pipe piece of the first pipe, in particular of the inner pipe. They can, however, also at least partly have an in particular round shape.

The nubs and the cut-outs are preferably distributed uniformly over the boundary of the respective pipe piece.

As already stated, at least some of the inner pipes can be supported by inner bases which are provided with cut-outs through which the respective inner pipes are led. The inner pipes can in this respect be fixedly connected, in particular welded, to the inner bases.

The jacket of the housing can in particular be produced in a shell-like manner of construction or in a wrapped manner of construction. Whereas in particular two deep-drawn metal sheets are connected to one another at the marginal side in the shell-like manner of construction, a metal sheet is wrapped around a core and closed in the wrapped manner of construction.

The invention will be explained in more detail in the following with reference to an embodiment and to the drawing;

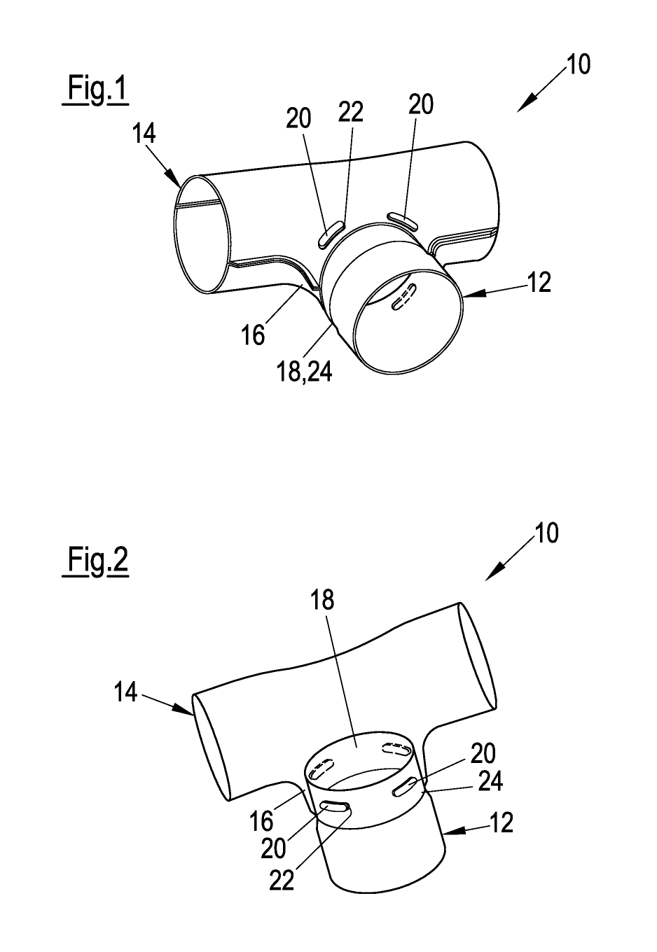

FIG. 1 a schematic perspective representation of a connection between an inlet or outlet pipe and an inner pipe of an exemplary embodiment of a muffler in accordance with the invention;

FIG. 2 a further schematic perspective representation of the connection in accordance with FIG. 1;

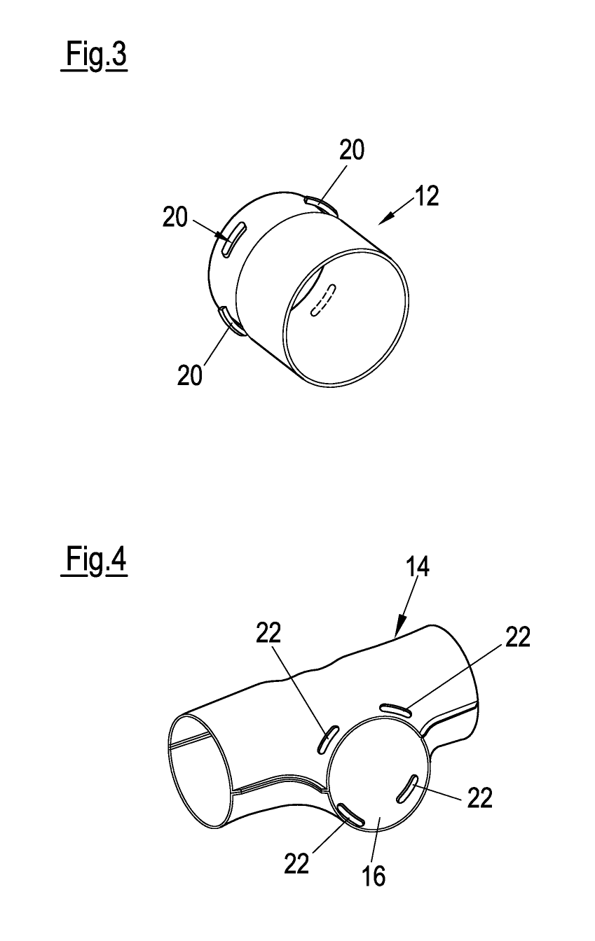

FIG. 3 a schematic perspective representation of the inlet or outlet pipe already provided with nubs;

FIG. 4 a schematic perspective representation of the inner pipe;

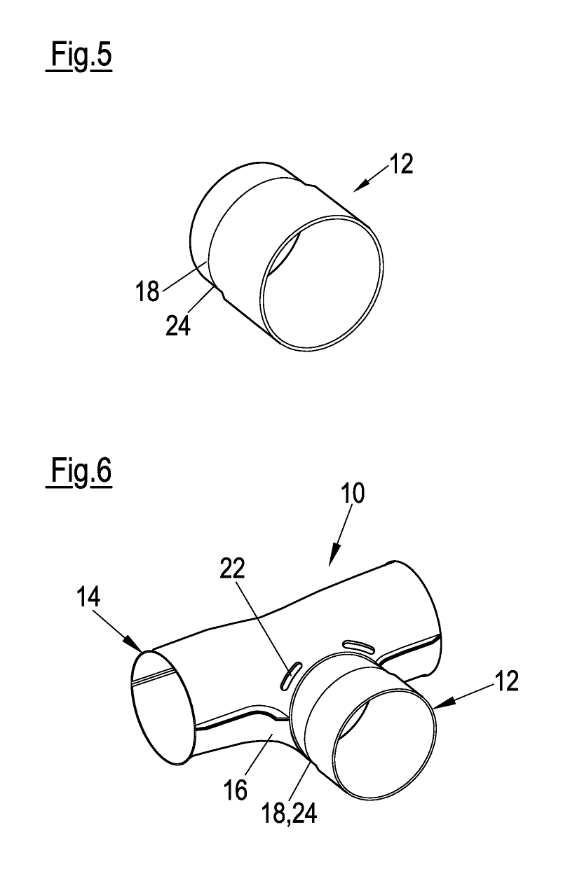

FIG. 5 a schematic perspective representation of the inlet or outlet pipe not yet provided with nubs; and

FIG. 6 a schematic perspective representation of the connection in accordance with FIG. 1 in a phase in which the end section of the inlet or outlet pipe is admittedly already plugged into the pipe piece of the inner pipe but is not yet provided with nubs.

FIGS. 1 to 6 show a schematic perspective representation of a part of an exemplary embodiment of a muffler 10 in accordance with the invention, in particular of a rear muffler, for an exhaust gas system of an internal combustion engine, in particular a motor vehicle engine.

The muffler 10 has a housing (not shown) comprising a jacket and two end walls and has at least one inlet or outlet pipe 12 which is in particular led through the jacket and which is connected to an inner pipe 14.

The inner pipe 14 has a pipe piece 16 which is formed as a lateral branch and into which an end section 18 of the inlet or outlet pipe 12 is plugged.

In the installed state, the end section 18 of the inlet or outlet pipe 12 is provided with nubs 20 at its outer boundary which engage into cut-outs 22 provided in the pipe piece 16 of the inner pipe 14. After the plugging together of the inlet or outlet pipe 12 and the inner pipe 14 has taken place, the nubs 20 can in particular be introduced into the end section 18 of the inlet or outlet pipe 12 from the inside by a suitable tool. In this respect, the cut-outs 22 are dimensioned larger with respect to the nubs 20 so that the end section 18 of the inlet or outlet pipe 12 is, on the one hand, fixed in the pipe piece 16 of the inner pipe 14, i.e. it is connected in an unlosable manner thereto, but can be axially displaced to a limited degree relative to the pipe piece 16 to allow a compensation of thermal expansions.

The end section 18 of the inlet or outlet pipe 12 is moreover received secured against rotation in the pipe piece 16 by the cooperating nubs 20 and cut-outs 22 of the end section 18 of the inlet or outlet pipe 12 or of the pipe piece 16 of the inner pipe 14.

The end section 18 of the inlet or outlet pipe 12 plugged in the pipe piece 16 can be provided with an intake 24, i.e. with a cross-section reduction or a diameter reduction, whereby the axial displaceability of the end section 18 of the inlet or outlet pipe 12 in the pipe piece 16 of the inner pipe 14 is facilitated and an abutment is formed. The inlet or outlet pipe and the inner pipe are hereby directly pressed so that a support effect similar to a welded solution is possible but the axial thermal expansion of the inlet or outlet pipe is simultaneously possible. The inlet region of the muffler is improved with respect to the possible bending load by this support effect. The cross-sections or diameters of the pipe piece 16 and of the end section 18 of the inlet or outlet pipe 12 are coordinated with one another.

The inner pipe 14 can, as shown, for example, be formed as a Y pipe produced from two half-shells, wherein the pipe piece 16 is in this case provided as a lateral branch of the Y pipe. A different type of design of the inner pipe 14 is, however, generally also conceivable.

As can in particular be seen from FIGS. 1 to 3, the nubs 20 and the cut-outs 22 can at least partly have an elongate form extending in the boundary direction of the inlet or outlet pipe 12 or extending in the boundary direction of the pipe piece 16. However, such embodiments are also conceivable in which the nubs 20 and the cut-outs 22 at least partly have a round shape.

As shown, the nubs 20 and the cut-outs 22 can in particular be uniformly distributed over the boundary of the end section 18 of the inlet or outlet pipe 12 or over the boundary of the pipe piece 16.

The inner pipe 14, which is connected to the inlet or outlet pipe 12, can be connected to at least one further inner pipe. If the inner pipe 14, as shown, is formed, for example, as a Y pipe having a lateral branch, two further inner pipes can in particular be connected to this inner pipe 14. As already mentioned, a different type of design of the inner pipe 14 is, however, generally also conceivable.

A least some of the inner pipes can in particular be supported by inner bases (not shown) which are provided with cut-outs through which the respective inner pipes are led. The inner pipes can in this respect in particular be welded to the base passages.

The jacket of the housing of the muffler 10 can in particular be produced in a shell-like manner of construction or in a wrapped manner of construction. Whereas in particular two deep-drawn metal sheets are connected to one another at the marginal side in the shell-like manner of construction, a metal sheet is wrapped around a core and closed in the wrapped manner of construction.

FIGS. 1 and 2 show the connection between the inlet or outlet pipe 12 and the inner pipe 14 after installation has been completed. The inlet or outlet pipe 12 already provided with nubs 20 is shown in FIG. 3. FIG. 4 shows the inner pipe 14. The inlet or outlet pipe 12 not yet provided with nubs is shown in FIG. 5.

FIG. 6 shows the connection between the inlet or outlet pipe 12 and the inner pipe 14 in a phase in which the end section 18 of the inlet or outlet pipe 12 is admittedly already plugged into the pipe piece 16 of the inner pipe 14, but the end section 18 of the inlet or outlet pipe 12 is not yet provided with nubs 20. These nubs 20 can subsequently in particular be introduced into the end section 18 of the inlet or outlet pipe 12 from the inside by means of a suitable tool in order to establish the final connection shown in FIGS. 1 and 2 in which the nubs 20 formed at the outer boundary of the end section 18 of the inlet or outlet pipe 12 finally engage into the cut-outs 22 provided in the pipe piece 16.

### REFERENCE NUMERAL LIST

10 muffler
12 inlet or outlet pipe
14 inner pipe
16 pipe piece
18 end section
20 nub
22 cut-out
24 intake

1. A muffler for an exhaust gas system of an internal combustion engine, having a housing and having at least two pipes which are plugged into one another and which are at least partly received by the housing,
wherein the first pipe (14), comprises a pipe piece into which or onto which a pipe piece of the second pipe is plugged, wherein a loose form-fitted connection is provided between the pipe piece of the first pipe and the pipe piece of the second pipe so that the pipe piece of the second pipe is, on the one hand, fixed in the pipe piece of the first pipe, but can be axially displaced to a limited degree relative to the pipe piece of the first pipe.

2. The muffler in accordance with claim 1,
wherein the housing has a jacket and two end walls.

3. The muffler in accordance with claim 1, wherein the housing has at least one inlet pipe or wherein the housing has at least one outlet pipe, said inlet or outlet pipe being connected to an inner pipe.

4. The muffler in accordance with claim 3, wherein the housing has a jacket and two end walls and the inlet pipe is led through the jacket into the housing.

5. The muffler in accordance with claim 1, wherein the pipe piece of the second pipe is an end section.

6. The muffler in accordance with claim 1, wherein the first pipe is an inner pipe.

7. The muffler in accordance with claim 1,
wherein the pipe piece of the second pipe is provided with nubs at its outer boundary or at its inner boundary which engage into cut-outs provided in the pipe piece of the first pipe, with the cut-outs being dimensioned larger with respect to the nubs or wherein the pipe piece of the first pipe is provided with nubs at its outer boundary or at its inner boundary which engage into cut-outs provided in the pipe piece of the second pipe, with the cut-outs being dimensioned larger with respect to the nubs.

8. The muffler in accordance with claim 1,
wherein the pipe piece of the second pipe is received secured against rotation in the pipe piece of the first pipe by the cooperating nubs and cut-outs.

9. The muffler in accordance with claim 1,
wherein the pipe piece of the second pipe is provided with an intake, with the pipe piece of the second pipe being plugged into the pipe piece of the first pipe.

10. The muffler in accordance with claim 1,
wherein the first pipe is formed as a Y pipe and the pipe piece is provided as a lateral branch of the Y pipe or wherein the first pipe can be composed of two half-shells.

11. The muffler in accordance with claim 10, wherein the first pipe is an inner pipe.

12. The muffler in accordance with claim 7,
wherein the nubs and the cut-outs at least partly have an elongate form extending in the boundary direction of the pipe piece of the second pipe, or
extending in the boundary direction of the pipe piece of the first pipe, or
wherein the nubs and the cut-outs at least partly have a round shape.

13. The muffler in accordance with claim 7,
wherein the nubs and the cut-outs are uniformly distributed over the boundary of the pipe piece of the second pipe or over the boundary of the pipe piece of the first pipe.

14. The muffler in accordance with claim 6,
wherein the inner pipe is connected to at least one further pipe, an inner pipe.

15. The muffler in accordance with claim 1,
wherein at least some of the pipes are formed as inner pipes that are supported by inner bases which are provided with cut-outs through which the respective inner pipes are led.

16. The muffler in accordance with claim 1,
wherein the jacket of the housing is produced in a shell-like manner of construction.

17. The muffler in accordance with claim 1,
wherein the jacket of the housing is produced in a wrapped manner of construction.
